(19) United States
(12) Patent Application Publication
(10) Pub. No.: US 2024/0409469 A1
(43) Pub. Date: Dec. 12, 2024

(54) PREPARATION METHOD FOR HIGH-PERFORMANCE LITHIUM IRON PHOSPHATE AND USE THEREOF

(71) Applicants: YICHANG BRUNP CONTEMPORARY AMPEREX CO., LTD., Yichang, Hubei (CN); YICHANG BRUNP RECYCLING TECHNOLOGY CO., LTD., Yichang, Hubei (CN); GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(72) Inventors: Shiqing Zhang, Foshan, Guangdong (CN); Changdong Li, Foshan, Guangdong (CN); Rui Du, Foshan, Guangdong (CN); Dingshan Ruan, Foshan, Guangdong (CN); Jinming Sun, Foshan, Guangdong (CN); Cunpeng Qin, Foshan, Guangdong (CN)

(21) Appl. No.: 18/699,631

(22) PCT Filed: Feb. 20, 2023
(86) PCT No.: PCT/CN2023/077222

§ 371 Date: Apr. 9, 2024

(30) Foreign Application Priority Data
Apr. 12, 2022 (CN) 202210380031.9

(51) Int. Cl. C04B 35/447; C04B 35/626; C04B 35/64; H01M 10/0525

(52) U.S. Cl. CPC C04B 35/447; C04B 35/6261; C04B 35/62635; C04B 35/62655; C04B 35/64; H01M 10/0525; C04B 2235/447; C04B 2235/5436; C04B 2235/5445

(57) ABSTRACT

Disclosed are a preparation method for high-performance lithium iron phosphate and use thereof. The method comprises the following steps: dispersing a lithium salt into a solvent A, and adding an organic acid to adjust the pH to obtain a mixed solution; dispersing porous iron phosphate into a solvent B, and adding an organic carbon source to obtain a mixed slurry A; adding the mixed slurry A into the mixed solution; grinding the obtained slurry; adding a dispersing agent into the grinding material for stirring and dispersing to obtain a mixed slurry B; placing the mixed slurry B under the pressure of 100-1000 Pa for aging and drying; and sintering the obtained dry material in an inert atmosphere to obtain lithium iron phosphate.

### TECHNICAL FIELD

The present disclosure belongs to the technical field of preparation of lithium-ion battery (LIB) materials, and in particular relates to a preparation method for high-performance lithium iron phosphate (LFP) and use thereof.

### BACKGROUND

The new energy industry emerges with the depletion of petroleum resources and the increasing requirements of people for living environments. The electric vehicles have been widely popularized, and there are increasing demands for battery materials with high energy density, large capacity, and low cost. Compared with ternary materials, LFP has the advantages of high safety and low cost. The decline in the subsidy for new energy vehicles increases the cost reduction pressure of traction batteries, which enhances the market competitiveness of relatively-cheap LFP, and makes LFP in great demand on the market and even in short supply. The current products on the market generally have disadvantages such as insufficient product consistency, low capacity, and poor cycling performance. In view of this, it is urgent to develop an LFP product with stable performance and prominent cycling performance.

### SUMMARY

The present disclosure is intended to solve one of the technical problems existing in the prior art. In view of this, the present disclosure provides a preparation method for high-performance LFP and use thereof. The implementation of the preparation method is conducive to promoting the industrialization of LFP and the development of LIB industry.

According to an aspect of the present disclosure, a preparation method for LFP is provided, including the following steps:
S1: dispersing a lithium salt in a pre-prepared solvent A, and adjusting a pH to 6.5 to 8.5 with an organic acid to obtain a mixed solution; and dispersing porous iron phosphate in a pre-prepared solvent B, and adding an organic carbon source to obtain a mixed slurry A, where the solvents A and B are independently water or a dispersion liquid of a volatile solvent and water:
S2: adding the mixed slurry A to the mixed solution, milling a resulting slurry to obtain a milled material, adding a dispersing agent to the milled material, and stirring a resulting mixture for dispersion to obtain a mixed slurry B; and
S3: aging and drying the mixed slurry B under a pressure of 100 Pa to 1,000 Pa to obtain a dry material, and sintering the dry material in an inert atmosphere to obtain the LFP. It should be noted that the pressure of 100 Pa to 1,000 Pa is a gauge pressure.

The organic acid can avoid the introduction of impurities, and the adjustment of the pH to 6.5 to 8.5 can ensure that a structure of the porous iron phosphate will not be affected. The aging and drying under the specified pressure can control a vapor pressure, such that the dry material is in a homogeneous state.

In some embodiments of the present disclosure, in S1, the volatile solvent is one or more of ethanol, n-heptane, or n-amyl acetate. The volatile solvent helps to take away impurities, and can ensure the integrity under the structural state and the effectiveness of the reaction.

In some preferred embodiments of the present disclosure, in S1, when the solvents A and B are each selected from the group consisting of the dispersion liquid of the volatile solvent and water, a mass ratio of the volatile solvent to the water is (0.1-0.5):1.

In some embodiments of the present disclosure, in S1, a mass ratio of the lithium salt to the solvent A is (0.1-0.4):1.

In some embodiments of the present disclosure, in S1, the lithium salt is one or more of lithium oxide, lithium carbonate, lithium acetate, lithium hydroxide, lithium hydroxide monohydrate, or lithium nitrate.

In some embodiments of the present disclosure, in S1, a mass ratio of the porous iron phosphate to the solvent B is (0.3-0.6):1.

In some embodiments of the present disclosure, in S1, a molar ratio of Fe in the porous iron phosphate to Li in the lithium salt is (0.95-1.0):1.

In some embodiments of the present disclosure, in S1, a mass ratio of the organic carbon source to the porous iron phosphate is (0.05-0.3):1.

In some embodiments of the present disclosure, in S1, the organic acid is one or more of formic acid, acetic acid, oxalic acid, citric acid, sulfinic acid, sulfonic acid, or aromatic acid.

In some embodiments of the present disclosure, in S1, the porous iron phosphate has a particle size D50 of 1 μm to 20 μm, a porosity of 25% to 55%, and a pore size of 50 nm or less.

In some embodiments of the present disclosure, in S1, the organic carbon source is one or more of starch, sucrose, cellulose, anhydrous glucose, glucose monohydrate, polyvinyl alcohol (PVA), polyethylene glycol (PEG), polyacrylic acid (PAA), polyvinylpyrrolidone (PVP), or chitin.

In some embodiments of the present disclosure, in S2, the dispersing agent is one or more of Tween, isopropyl alcohol (IPA), glycerol, phenolic resin, ethyl acetate, or epoxy resin.

In some embodiments of the present disclosure, in S2, the dispersing agent is added at an amount 1% to 5% of a mass of the porous iron phosphate.

In some embodiments of the present disclosure, in S2, the stirring for dispersion is conducted for 0.2 h to 1 h.

In some embodiments of the present disclosure, in S2, the milled material has a particle size D50 of 0.1 μm to 2.0 μm.

In some embodiments of the present disclosure, in S3, the aging and drying is conducted at 60° C. to 120° C. for 5 h to 48 h.

In some embodiments of the present disclosure, in S3, the sintering is conducted as follows: in the inert atmosphere, heating to 600° C. to 800° C. at 1° C./min to 10° C./min, and holding the temperature for 4 h to 18 h.

In some embodiments of the present disclosure, in S3, after the sintering, a sintering product is subjected to air-jet pulverization, and LFP obtained after the air-jet pulverization has a particle size D50 of 0.4 μm to 3.0 μm.

The present disclosure also provides use of the preparation method described above in the preparation of an LIB.

According to a preferred embodiment of the present disclosure, the present disclosure at least has the following beneficial effects.

In the present disclosure, solvents with specified volatility and chemical mildness are pre-prepared, and the characteristics such as acidity and stability of mixed solutions in the process are controlled, ensuring that the structure of the porous iron phosphate is more stable in the system. In addition, the temperature-controlled aging reactor is controlled at a specified pressure for slow drying, such that the dry material is in a homogeneous state. In summary, the lithium salt and the organic carbon source are stably embedded in the structure of the porous iron phosphate, the reaction is more effective and sufficient, and the impurity phases in the finished product are reduced, such that the prepared product has a more uniform rounded particle morphology and exhibits excellent electrochemical performance and long cycling performance. The LFP product of the present disclosure can lead to a specific discharge capacity of 159 mAh/g at 0.1 C, an initial efficiency of 97% or higher, and a capacity retention of 94% or higher after 1,500 cycles at 1 C, and is a high-performance and long-cycling LFP material, which is of an important guiding significance for promoting the rapid development of the LFP traction battery and new energy industries.

### BRIEF DESCRIPTION OF THE DRAWINGS

The present disclosure is further described below with reference to accompanying drawings and examples.

FIG. 1 is an X-ray diffraction (XRD) pattern of the LFP in Example 3 of the present disclosure; and

FIG. 2 is a scanning electron microscopy (SEM) image of the LFP in Example 3 of the present disclosure.

### DETAILED DESCRIPTION

The concepts and technical effects of the present disclosure are clearly and completely described below in conjunction with examples, such as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

High-performance LFP was prepared in this example, and a specific preparation process was as follows:

(1) A solvent A with specified volatility and chemical mildness was pre-prepared with water and ethanol, then lithium carbonate was dispersed in the solvent A, a resulting mixture was stirred for uniform dispersion, and then a pH was adjusted to 7.5 with acetic acid to obtain a mixed solution, where a mass of the ethanol was 35% of a mass of the water and a mass of the lithium salt was controlled to be 20% of a mass of the solvent A; and porous iron phosphate (with a particle size D50 of 8.5 μm, a porosity of 36%, and a pore size of about 32 nm) was dispersed in a pre-prepared solvent B (a composition of the solvent B was consistent with the composition of the solvent A), then sucrose and PEG were added into the solvent B, and a resulting mixture was stirred for uniform dispersion to obtain a mixed slurry A, where a mass of the porous iron phosphate was controlled to be 50% of a mass of the solvent B, a molar ratio of Fe in the porous iron phosphate to Li in the lithium salt was controlled to be 0.96:1, a total mass of the sucrose and PEG was controlled to be 14% of the mass of the porous iron phosphate, and a mass of the sucrose was controlled to be 1.3 times a mass of the PEG.

(2) Under continuous stirring, the mixed solution was slowly added to the mixed slurry A, a slurry obtained after uniform dispersion was milled with a sand mill at a discharge particle size D50 of 0.335 μm, then Tween and IPA were added, and a resulting mixture was stirred for dispersion for 0.5 h to obtain a mixed slurry B, where a total mass of the Tween and IPA was 2.5% of the mass of the porous iron phosphate and a mass of the Tween was 2.0 times a mass of the IPA.

(3) The mixed slurry B was placed in a temperature-controlled aging reactor, and then slowly aged and dried for 36 h at about 200 Pa and 80° C. to obtain a dry material: the dry material was sintered and crushed: under a pure nitrogen atmosphere, the dry material was heated to 700° C. at 3° C./min and kept at the temperature for 10 h, then cooled, and discharged; and a sintered material was subjected to air-jet pulverization at a discharge particle size D50 of about 1.5 μm to obtain the high-performance LFP material.

### Example 2

High-performance LFP was prepared in this example, and a specific preparation process was as follows:

(1) A solvent A with specified volatility and chemical mildness was pre-prepared with water and n-heptane, then lithium hydroxide monohydrate was dispersed in the solvent A, a resulting mixture was stirred for uniform dispersion, and then a pH was adjusted to 7.8 with oxalic acid to obtain a mixed solution, where a mass of the n-heptane was 24% of a mass of the water and a mass of the lithium salt was controlled to be 30% of a mass of the solvent A; and porous iron phosphate (with a particle size D50 of 10.2 μm, a porosity of 31%, and a pore size of about 24 nm) was dispersed in a pre-prepared solvent B (a composition of the solvent B was consistent with the composition of the solvent A), then anhydrous glucose and PVA were added into the solvent B, and a resulting mixture was stirred for uniform dispersion to obtain a mixed slurry A, where a mass of the porous iron phosphate was controlled to be 40% of a mass of the solvent B, a molar ratio of Fe in the porous iron phosphate to Li in the lithium salt was controlled to be 0.97:1, a total mass of the anhydrous glucose and PVA was controlled to be 21% of the mass of the porous iron phosphate, and a mass of the anhydrous glucose was controlled to be 1.5 times a mass of the PVA.

(2) Under continuous stirring, the mixed solution was slowly added to the mixed slurry A, a slurry obtained after uniform dispersion was milled with a sand mill at a discharge particle size D50 of 0.450 μm, then glycerol and ethyl acetate were added, and a resulting mixture was stirred for dispersion for 1 h to obtain a mixed slurry B, where a total mass of the glycerol and ethyl acetate was 3% of the mass of the porous iron phosphate and a mass of the glycerol was 3.0 times a mass of the ethyl acetate.

(3) The mixed slurry B was placed in a temperature-controlled aging reactor, and then slowly aged and dried for 32 h at about 350 Pa and 90° C. to obtain a dry material: the dry material was sintered and crushed: under a pure nitrogen atmosphere, the dry material was heated to 730° C. at 5° C./min and kept at the temperature for 9 h, then cooled, and discharged; and a sintered material was subjected to air-jet pulverization at a discharge particle size D50 of about 1.7 μm to obtain the high-performance LFP material.

### Example 3

High-performance LFP was prepared in this example, and a specific preparation process was as follows:

(1) A solvent A with specified volatility and chemical mildness was pre-prepared with water, ethanol, and n-heptane, then lithium hydroxide was dispersed in the solvent A, a resulting mixture was stirred for uniform dispersion, and then a pH was adjusted to 7.3 with citric acid and acetic acid to obtain a mixed solution, where a mass of the ethanol was 12% of a mass of the water, a mass of the n-heptane was 15% of the mass of the water, and a mass of the lithium salt was controlled to be 35% of a mass of the solvent A; and porous iron phosphate (with a particle size D50 of 4.6 μm, a porosity of 36%, and a pore size of about 38 nm) was dispersed in a pre-prepared solvent B (a composition of the solvent B was consistent with the composition of the solvent A), then anhydrous glucose and PAA were added into the solvent B, and a resulting mixture was stirred for uniform dispersion to obtain a mixed slurry A, where a mass of the porous iron phosphate was controlled to be 30% of a mass of the solvent B, a molar ratio of Fe in the porous iron phosphate to Li in the lithium salt was controlled to be 0.97:1, a total mass of the anhydrous glucose and PAA was controlled to be 12% of the mass of the porous iron phosphate, and a mass of the anhydrous glucose was controlled to be 1.6 times a mass of the PAA.

(2) Under continuous stirring, the mixed solution was slowly added to the mixed slurry A, a slurry obtained after uniform dispersion was milled with a sand mill at a discharge particle size D50 of 0.350 μm, then Tween and ethyl acetate were added, and a resulting mixture was stirred for dispersion for 0.5 h to obtain a mixed slurry B, where a total mass of the Tween and ethyl acetate was 6% of the mass of the porous iron phosphate and a mass of the Tween was 2.7 times a mass of the ethyl acetate.

(3) The mixed slurry B was placed in a temperature-controlled aging reactor, and then slowly aged and dried for 24 h at about 450 Pa and 100° C. to obtain a dry material: the dry material was sintered and crushed: under a pure nitrogen atmosphere, the dry material was heated to 745° C. at 2° C./min and kept at the temperature for 9 h, then cooled, and discharged; and a sintered material was subjected to air-jet pulverization at a discharge particle size D50 of about 1.2 μm to obtain the high-performance LFP material.

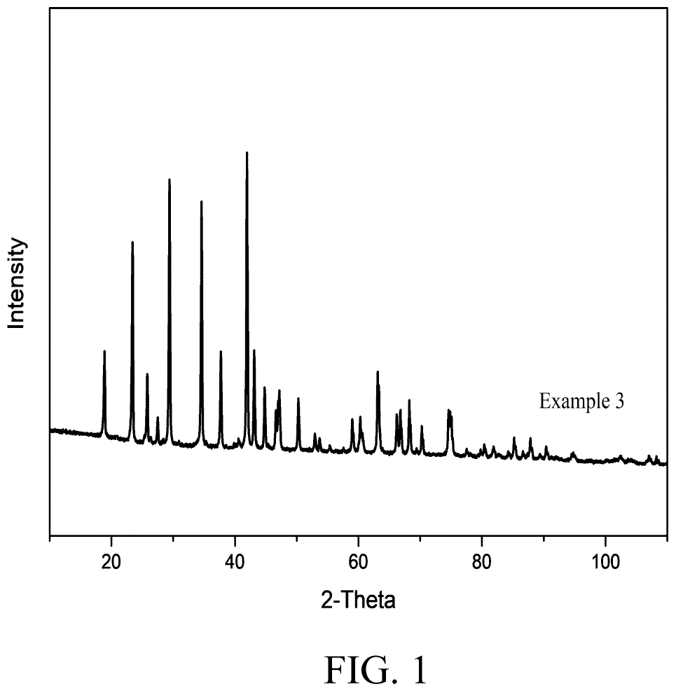

FIG. 1 is an XRD pattern of the LFP in this example. It can be seen from the figure that peaks of the material are consistent with that of the LFP standard card and there is no impurity peak, indicating that the material is LFP, has no impurity phase, and exhibits excellent crystallinity.

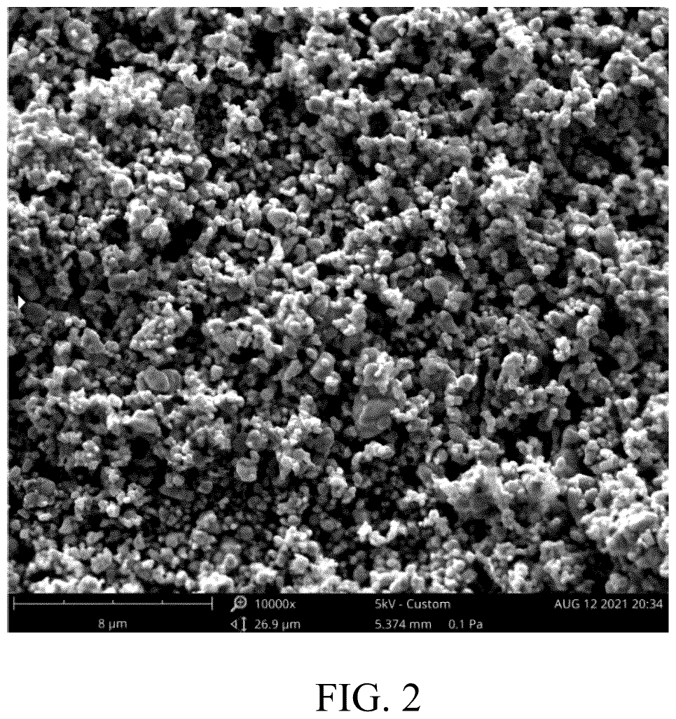

FIG. 2 is an SEM image of the LFP in this Example 3. It can be seen from the figure that the material has uniform rounded particles, with prominent carbon coating, which plays an important role in the stability of the performance of the material.

### Example 4

High-performance LFP was prepared in this example, and a specific preparation process was as follows:

(1) A solvent A with specified volatility and chemical mildness was pre-prepared with water, ethanol, and n-amyl acetate, then lithium nitrate was dispersed in the solvent A, a resulting mixture was stirred for uniform dispersion, and then a pH was adjusted to 6.8 with acetic acid to obtain a mixed solution, where a mass of the ethanol was 10% of a mass of the water, a mass of the n-amyl acetate was 18% of the mass of the water, and a mass of the lithium salt was controlled to be 40% of a mass of the solvent A; and porous iron phosphate (with a particle size D50 of 14.6 μm, a porosity of 26%, and a pore size of about 23 nm) was dispersed in a pre-prepared solvent B (a composition of the solvent B was consistent with the composition of the solvent A), then anhydrous glucose and chitin were added into the solvent B, and a resulting mixture was stirred for uniform dispersion to obtain a mixed slurry A, where a mass of the porous iron phosphate was controlled to be 40% of a mass of the solvent B, a molar ratio of Fe in the porous iron phosphate to Li in the lithium salt was controlled to be 0.98:1, a total mass of the anhydrous glucose and chitin was controlled to be 16% of the mass of the porous iron phosphate, and a mass of the anhydrous glucose was controlled to be 2.2 times a mass of the chitin.

(2) Under continuous stirring, the mixed solution was slowly added to the mixed slurry A, a slurry obtained after uniform dispersion was milled with a sand mill at a discharge particle size D50 of 0.568 μm, then Tween and glycerol were added, and a resulting mixture was stirred for dispersion for 0.09 h to obtain a mixed slurry B, where a total mass of the Tween and glycerol was 9% of the mass of the porous iron phosphate and a mass of the Tween was 80% of a mass of the glycerol.

(3) The mixed slurry B was placed in a temperature-controlled aging reactor, and then slowly aged and dried for 30 h at about 400 Pa and 95° C. to obtain a dry material: the dry material was sintered and crushed: under a pure nitrogen atmosphere, the dry material was heated to 720° C. at 4° C./min and kept at the temperature for 10 h, then cooled, and discharged; and a sintered material was subjected to air-jet pulverization at a discharge particle size D50 of about 1.9 μm to obtain the high-performance LFP material.

### Example 5

High-performance LFP was prepared in this example, and a specific preparation process was as follows:

(1) A solvent A with specified volatility and chemical mildness was pre-prepared with water and n-amyl acetate, then lithium carbonate was dispersed in the solvent A, a resulting mixture was stirred for uniform dispersion, and then a pH was adjusted to 8.0 with oxalic acid to obtain a mixed solution, where a mass of the n-amyl acetate was 25% of a mass of the water and a mass of the lithium salt was controlled to be 20% of a mass of the solvent A; and porous iron phosphate (with a particle size D50 of 15.8 μm, a porosity of 41%, and a pore size of about 19 nm) was dispersed in a pre-prepared solvent B (a composition of the solvent B was consistent with the composition of the solvent A), then starch and PEG were added into the solvent B, and a resulting mixture was stirred for uniform dispersion to obtain a mixed slurry A, where a mass of the porous iron phosphate was controlled to be 40% of a mass of the solvent B, a molar ratio of Fe in the porous iron phosphate to Li in the lithium salt was controlled to be 0.99:1, a total mass of the starch and PEG was controlled to be 17% of the mass of the porous iron phosphate, and a mass of the starch was controlled to be 1.1 times a mass of the PEG.

(2) Under continuous stirring, the mixed solution was slowly added to the mixed slurry A, a slurry obtained after uniform dispersion was milled with a sand mill at a discharge particle size D50 of 0.605 μm, then IPA and phenolic resin were added, and a resulting mixture was stirred for dispersion for 1.0 h to obtain a mixed slurry B, where a total mass of the IPA and phenolic resin was 7% of the mass of the porous iron phosphate and a mass of the IPA was 2.8 times a mass of the phenolic resin.

(3) The mixed slurry B was placed in a temperature-controlled aging reactor, and then slowly aged and dried for 24 h at about 700 Pa and 110° C. to obtain a dry material: the dry material was sintered and crushed: under a pure nitrogen atmosphere, the dry material was heated to 785° C. at 5° C./min and kept at the temperature for 12 h, then cooled, and discharged; and a sintered material was subjected to air-jet pulverization at a discharge particle size D50 of about 1.6 μm to obtain the high-performance LFP material.

### Comparative Example

LFP was prepared in this Comparative Example, and a specific preparation process was as follows:

(1) Lithium hydroxide was dispersed in water, and a resulting mixture was stirred for uniform dispersion to obtain a mixed solution, where a mass of the lithium salt was 40% of a mass of the solvent; and porous iron phosphate (with a particle size D50 of 18.8 μm, a porosity of 26%, and a pore size of about 49 nm) was dispersed in water, then anhydrous glucose and PAA were added, and a resulting mixture was stirred for uniform dispersion to obtain a mixed slurry A, where a mass of the porous iron phosphate was controlled to be 30% of a mass of the solvent, a molar ratio of Fe in the porous iron phosphate to Li in the lithium salt was controlled to be 0.97:1, a total mass of the anhydrous glucose and PAA was controlled to be 12% of the mass of the porous iron phosphate, and a mass of the anhydrous glucose was controlled to be 3.5 times a mass of the PAA.

(2) Under continuous stirring, the mixed solution was rapidly added to the mixed slurry A, and a slurry obtained after uniform dispersion was milled with a sand mill at a discharge particle size D50 of 0.495 μm to obtain a milled material.

(3) The milled material was placed in a temperature-controlled aging reactor, and then slowly dried for 24 h at 140° C. under a non-controlled pressure (with a gauge pressure of about less than 10 Pa) to obtain a dry material: the dry material was sintered and crushed: under a pure nitrogen atmosphere, the dry material was heated to 745° C. at 2° C./min and kept at the temperature for 9 h, then cooled, and discharged; and a sintered material was subjected to air-jet pulverization at a discharge particle size D50 of about 1.2 μm to obtain the LFP material.

### Test Example

An electrical performance test was conducted according to the following method. Each of LFP samples of Examples 1 to 5 and the comparative example and a commercially-available product of the same type, a conductive agent, and polyvinylidene difluoride (PVDF) were weighed and mixed according to a mass ratio of 92:4:4, then N-methylpyrrolidone (NMP) was added to prepare a slurry, the slurry was stirred for 4 h and then coated on a surface of an aluminum foil at 115° C., and a resulting product was rolled, flaked, and assembled. With graphite as an anode, 1 mol/L LiPF₆ (EC:DEC=1:1) as an electrolyte, and a microporous polypropylene (PP) membrane as a separator, a soft-pack battery was assembled. After formation at 45° C., the soft-pack battery was subjected to a corresponding charge-discharge performance test with a battery test system at room temperature and a test voltage range of 2.0 V to 3.65 V.

TABLE 1
Electrochemical performance of LFP

| | | | Capacity retention |
|---|---|---|---|
| | Initial specific | Initial charge- | rate after |
| | discharge | discharge | 1,500 cycles |
| | capacity at | efficiency | at 1.0 C and |
| Sample | 0.1 C (mAh/g) | at 0.1 C (%) | room temperature |
| Example 1 | 158.4 | 97.60 | 94.2% |
| Example 2 | 159.0 | 97.82 | 94.5% |
| Example 3 | 158.7 | 98.64 | 95.6% |
| Example 4 | 157.3 | 98.25 | 95.3% |
| Example 5 | 156.9 | 97.24 | 94.1% |
| Comparative | 154.8 | 97.13 | 86.4% |
| Example | | | |
| Commercially- | 156.8 | 97.20 | 90.6% |
| available | | | |
| product | | | |

The comparison of the results in Table 1 shows that the LFP material prepared by the present disclosure shows excellent charge-discharge performance and long cycling performance in the battery application. This is because in the examples, the dispersibility and stability of a system are comprehensively improved by adjusting a pH with an organic acid, adding a dispersing agent, and controlling a drying vapor pressure, to ensure that the lithium salt and the organic carbon source are fully and stably embedded in the porous iron phosphate structure, such that the reaction is more efficient and sufficient, which reduces the generation of impurity phases in the finished product and ultimately improves the specific capacity and cycling performance.

The examples of the present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples and features in the examples in the present disclosure may be combined with each other in a non-conflicting situation.

1. A preparation method for lithium iron phosphate (LFP), comprising the following steps:
S1: dispersing a lithium salt in a pre-prepared solvent A, and adjusting a pH to 6.5 to 8.5 with an organic acid to obtain a mixed solution; and dispersing porous iron phosphate in a pre-prepared solvent B, and adding an organic carbon source to obtain a mixed slurry A, wherein the solvents A and B are independently water or a dispersion liquid of a volatile solvent and water;
S2: adding the mixed slurry A to the mixed solution, milling a resulting slurry to obtain a milled material, adding a dispersing agent to the milled material, and stirring a resulting mixture for dispersion to obtain a mixed slurry B; and
S3: aging and drying the mixed slurry B under a pressure of 100 Pa to 1,000 Pa to obtain a dry material, and sintering the dry material in an inert atmosphere to obtain the LFP.

2. The preparation method according to claim 1, wherein in S1, the volatile solvent is one or more of ethanol, n-heptane, or n-amyl acetate.

3. The preparation method according to claim 1, wherein in S1, the lithium salt is one or more of lithium oxide, lithium carbonate, lithium acetate, lithium hydroxide, lithium hydroxide monohydrate, or lithium nitrate.

4. The preparation method according to claim 1, wherein in S1, the organic acid is one or more of formic acid, acetic acid, oxalic acid, citric acid, sulfinic acid, sulfonic acid, or aromatic acid.

5. The preparation method according to claim 1, wherein in S1, the porous iron phosphate has a particle size D50 of 1 μm to 20 μm, a porosity of 25% to 55%, and a pore size of 50 nm or less.

6. The preparation method according to claim 1, wherein in S1, the organic carbon source is one or more of starch, sucrose, cellulose, anhydrous glucose, glucose monohydrate, polyvinyl alcohol (PVA), polyethylene glycol (PEG), polyacrylic acid (PAA), polyvinylpyrrolidone (PVP), or chitin.

7. The preparation method according to claim 1, wherein in S2, the dispersing agent is one or more of Tween, isopropyl alcohol (IPA), glycerol, phenolic resin, ethyl acetate, or epoxy resin.

8. The preparation method according to claim 1, wherein in S2, the milled material has a particle size D50 of 0.1 μm to 2.0 μm.

9. The preparation method according to claim 1, wherein in S3, the aging and drying is conducted at 60° C. to 120° C. for 5 h to 48 h.

10. A preparation method for a lithium-ion battery (LIB), comprising the preparation method for lithium iron phosphate (LFP) according to claim 1.

11. A preparation method for a lithium-ion battery (LIB), comprising the preparation method for lithium iron phosphate (LFP) according to claim 2.

12. A preparation method for a lithium-ion battery (LIB), comprising the preparation method for lithium iron phosphate (LFP) according to claim 3.

13. A preparation method for a lithium-ion battery (LIB), comprising the preparation method for lithium iron phosphate (LFP) according to claim 4.

14. A preparation method for a lithium-ion battery (LIB), comprising the preparation method for lithium iron phosphate (LFP) according to claim 5.

15. A preparation method for a lithium-ion battery (LIB), comprising the preparation method for lithium iron phosphate (LFP) according to claim 6.

16. A preparation method for a lithium-ion battery (LIB), comprising the preparation method for lithium iron phosphate (LFP) according to claim 7.

17. A preparation method for a lithium-ion battery (LIB), comprising the preparation method for lithium iron phosphate (LFP) according to claim 8.

18. A preparation method for a lithium-ion battery (LIB), comprising the preparation method for lithium iron phosphate (LFP) according to claim 9.
